(19) United States
(12) Patent Application Publication
(10) Pub. No.: US 2002/0072930 A1
(43) Pub. Date: Jun. 13, 2002

(54) System and method for motivating submission of real estate referrals

(76) Inventor: Larry Scites, Bloomington, IN (US)

Correspondence Address: Michael B. McNeil, Liell & McNeil Attorneys PC, P.O. Box 2417, Bloomington, IN, 47402, US

(21) Appl. No.: 10/017,699

(22) Filed: Dec. 7, 2001

Related U.S. Application Data
(60) Provisional application No. 60/251,973, filed on Dec. 8, 2000.

(51) Int. Cl. G06F 17/60

(52) U.S. Cl. 705/1

(57) ABSTRACT

A system and method are disclosed for encouraging buyers and sellers of real estate to submit requests for real estate referrals to a real estate referral management system. The system processes each referral and places it with a participating real estate professional who agrees to pay the system a “referral fee” upon the successful completion of the referees real estate transaction. As an inducement, the system will donate a substantial portion of any commission it receives to a charity of the real estate customers choice. In many states, the referee may also be able to personally take an income tax deduction for the donation, thus producing an added benefit and incentive. The real estate referral management system is designed to be painless to both the real estate customer and the charity to which the referee wishes the donation to go.

### RELATION TO OTHER PATENT APPLICATION

This application claims priority to co-pending provisional application Ser. No. 60/251,973, filed Dec. 8, 2000.

### TECHNICAL FIELD

The present invention relates generally to real estate broker commission fees, and more particularly to a system and method for diverting a portion of a real estate broker referral fee to charity.

### BACKGROUND

The buying and selling of real estate is heavily regulated. In addition, many of these regulations vary from state to state. However, one regulation that is consistent in all fifty states is a rule that forbids anyone without a valid current real estate broker's license from sharing in any real estate brokerage commission earned as a result of selling a parcel of real estate. In other words, in all fifty states a person can represent themselves in the purchase or sale of real estate, but can only be represented in such a purchase or sale by a licensed real estate broker. Typical real estate brokerage commission fees range from about five to eight percent of the purchase price. If the buyer and seller are represented by different real estate brokers, the commission fee is typically split evenly between the two brokers. If a single broker represents both buyer and seller, that broker is entitled to the entire commission fee. However, brokerage commission fees are often further split in a manner not evident when examining a real estate closing balance sheet. For instance, real estate brokers often split their fees with another real estate broker, if that other real estate broker referred the customer that bought or sold the real estate.

Real estate brokers in the United States refer business to each other thousands of times each day. Any time one real estate broker sends business to another real estate broker, he or she usually expects to be paid a referral fee of between 25% and 30% of the total commission earned by the receiving Realtor. This commission is usually designated per “side”, since real estate involves both a buying and a selling side. For example, if a broker refers a buyer, he will expect a referral fee on the buying side of the transaction. If he refers a seller, the same occurs but just on the other “side”. If he refers someone who buys and sells, he will expect a referral on both sides. These amounts may vary considerably. Listing commissions are determined by a listing contract and the amount of the commission offered to the buying broker is usually the percentage offered in some local multiple listing service.

Referrals usually involve listing a home for sale or helping someone purchase a home. One typical scenario could involve a home owner that accepts a job requiring relocation. He calls a Realtor to list his existing home for sale. The listing Realtor inquires if the home owner has found a Realtor in his new location. Sometimes the home owner has, but usually at this early stage has not. The listing agent offers to do some research and make a referral. He does so, and refers the homeowner to a new Realtor who helps him purchase a new home. If the new Realtor is successful in representing the homeowner in the purchase of a new home, he will earn a commission. He will then share this commission with the original referring Realtor, with the amount typically being on the order of 25% to 30% of his earned commission. In another example, a person is retiring and wants to sell his current home and purchase a smaller home in the country. He calls a friend who is no longer active in real estate (but still has a valid real estate brokers license) for a referral. His friend refers him to a Realtor who lists his home for sale. Either his friend or his new Realtor also refers him to still another Realtor who helps him buy his home in the country. In this case, two referral fees are paid, one for the referral involving the listing of his current home, and a second referral for helping him buy his new home. These referral fees are typically paid completely without the home buyers or home sellers knowledge. Since it is a referral, it does not have to be disclosed to anyone or appear on any closing documents. It is simply one real estate person sharing his commission with another real estate person. It is important to note that these referral fees are not something the average consumer could earn for himself even if he were aware of it and did the work himself. It is against the law in every state for a real estate person to share his or her commission with anyone who does not have a valid real estate brokers license.

Over the years, corporate America recognized that real estate broker referral fees were an opportunity for them to recover revenue that would otherwise be lost to them in a typical relocation process. Realizing that the commission could only be shared with another real estate broker, these corporations set up their own “in house” real estate brokerages and demanded 30% referral fees from anyone wishing to do business with them. This practice is now so well accepted that in every city in the United States, real estate companies now actually compete for the privilege of paying this 30% referral fee. There has been little resistance in the real estate industry to the referral fee system, since the referral simply replaces the advertising dollars a Realtor would otherwise be paying in order to gain new customers. Referrals are generally many times more valuable than general media leads. In fact, nationwide statistics suggest that a real estate broker is eight times more likely to help a referral client buy a home than a lead that just calls into the office. Thus, while Realtors are forbidden from sharing their commissions with anyone who does not have a valid real estate broker's license, they nevertheless are free to collect referral fees from almost anyone to whom they can send business.

The present invention is directed to diverting real estate commission money away from real estate professionals and to charitable organizations.

### SUMMARY OF THE INVENTION

In one aspect, a method of motivating submission of real estate referrals includes a step of obtaining a real estate broker's license for a real estate referral management system. A real estate customer is referred by the real estate referral management system to another licensed real estate broker. The real estate referral management systems pays at least a 20% portion of its broker referral fee to a charity chosen by the real estate customer.

In another aspect, a method of diverting real estate commission money to a charity includes a step of obtaining a real estate broker's license for a real estate referral management system, which refrains from direct representation of real estate customers in real estate transactions. The real estate referral management system and a real estate customer enter into an agreement regarding payment of a portion of a broker referral fee to a charity. The real estate customer is referred to another real estate broker after entering into the agreement. Finally, the real estate referral management system pays at least a 20% portion of its broker referral fee to a charity chosen by the real estate customer.

A real estate referral management system is a legal entity that has a real estate broker's license, but avoids direct representation of buyers and sellers in real estate transactions. The system includes means for identifying other real estate brokers that do directly represent at least one of buyers and sellers in real estate transactions. In addition, the system includes a means for referring a real estate customer to one of the other real estate brokers, and a means for legally transferring at least a portion of a broker referral fee to a charity chosen by the real estate customer.

### DETAILED DESCRIPTION

The first step in practicing the method of the present invention is to establish a real estate referral management system. This can be any recognized type of legal entity, but is preferably a for-profit corporation. The next step is to have the real estate referral management system (RERMS). The RERMS should then apply for and obtain a real estate broker's license in at least one state in a conventional manner.

Although not necessary, the RERMS should also obtain membership in the relevant trade organization, which is currently known as the National Association of Realtors. Membership in this trade organization is believed to increase the likelihood of the RERMS receiving referral fees for real estate customers it refers to other real estate brokers. Preferably, any real estate broker to whom a real estate customer is referred should also be a member of the National Association of Realtors. A code of ethics for the National Association of Realtors requires its members to abide by contracts with other brokers in order to maintain their membership in good standing. In other words, it is “unethical” for a Realtor to accept a referral from another Realtor and agree to pay a referral without compensating that referring Realtor. Of course all commission fees are contingent upon the successful completion of a real estate transaction for the real estate customer. Thus, by exploiting the membership code of ethics in the National Association of Realtors, the RERMS has a means of enforcing payment of a broker referral fee. Preferably, the RERMS will refer real estate customers only to other real estate brokers that are also members of the National Association of Realtors. Although the RERMS obtains a real estate broker's license, it preferably does not engage in the direct representation of buyers and/or sellers in real estate transactions. Although the RERMS in accordance with the present invention could directly represent buyers and sellers, by avoiding such direct representation the RERMS can enhance its perception as being impartial, while also avoiding the appearance of competing with other real estate brokers that do directly represent buyers and sellers. This aspect of the invention also would permit the RERMS to operate effectively in a locality since it would not be in the business of listing homes for sale and/or directly representing a buyer in the purchase of a home in competition with other Realtors.

There has been considerable legislation, debate and court review in various states concerning the issue of “rebates” of all or a portion of a real estate commission. In some states, including Indiana, a real estate broker can rebate back to their client all or part of his commission as long as all parties in the transaction are informed in writing by the time the offer to purchase is signed. This provides a solution for the present invention. At the earliest opportunity, the RERMS will enter into a contract with the real estate customer. The contract will require that the RERMS pay a portion of any referral fee to a charity of the customers choice. The contract will make it clear that this money is a rebate to the client directly. The contract should also give the RERMS authority to send the “rebate” as a contribution to a charity of the customers choice in their name. In this way, the customer can donate money to a charity of their choice without costing them anything, and the circumstances might even justify them taking a charitable tax deduction on their federal income tax return. Furthermore, since the money is going to a charity in their name, they have a vested interest in ensuring that the referral fee is paid.

Although there are exceptions, most real estate brokerage referrals are not a local matter. For instance, real estate brokers routinely refer customers to other real estate brokers in other states tens of thousands of times per year, but rarely refer a local customer to another local Realtor. One exception might be a case where a customer is seeking to sell commercial real estate, but the sale of commercial real estate may be outside of the expertise of the original Realtor contacted by the customer. In such a case, the Realtor might refer the customer to another local Realtor who has some special expertise in selling commercial real estate. Another reason that a Realtor might refer a customer to another local Realtor could be because of a real or perceived conflict of interest. Thus, while real estate transactions are by their nature generally local to the real estate at issue, real estate referrals almost always occur between two separated localities.

In a typical referral situation, a customer will contact a real estate broker. This could be done either by contacting a local Realtor in the customers area or possibly by contacting a non-local Realtor via telephone or possibly even the internet. Before actually making a referral, the Realtor will contact another Realtor in the locality where the customer is in need of real estate services. The two Realtors will then typically negotiate an agreement by which some portion, usually 25%-30%, of the referred Realtors commission will be shared with the referring Realtor. These agreements are often documented and put into written form via an exchange of faxes and/or emails between the two Realtors. At this point, the Realtors have a legally enforceable contract. However, those skilled in the art will recognize that the amounts of money at stake in these contracts, which is usually on the order of about one thousand dollars or less, are not sufficiently high to justify the expense of possibly hiring a lawyer in the remote location in order to enforce the referral fee agreement. Enforcement of the agreement is typically more easily enforced by contacting the local board of Realtors at the remote location with a complaint against one of their members for engaging in unethical conduct for failing to abide by a contract with another Realtor. The local board of Realtors is a branch of the National Association of Realtors. If the remote Realtor refuses to pay the referral fee after the right to payment has been verified, the remote Realtor could be punished by being ejected for the National Association of Realtors, which also would prevent them from taking advantage of the multiple listing service. Such a tactic is usually sufficient to motivate payment of the referral fee since it is typically much more valuable for a Realtor to remain in good standing with the National Trade Organization than it is to withhold payment of a fee, which is typically on the order of one thousand or less dollars.

In almost all cases, the “rebate” is not considered income for income tax purposes. Technically, it is usually considered a rebate of the costs associated with the buying or selling of the home. This amount is typically added to the basis used to calculate the value of the home in the situation that you would be subject to a capital gains tax on the sale of the home. Since there is now no capitol gains tax on the sale of a principal residence for most individuals if you have lived in the home two of the last five years, very few people, if any, will typically ever have to be concerned with this. In another aspect, tax considerations can be an important aspect of the present invention. For instance, the RERMS should have the ability to take a tax deduction for the amount of the commission transferred to the charity chosen by the customer, since it is an ordinary and necessary business expense for that company. In addition, the individual customer may also have the ability to take a charitable tax deduction for the money forwarded to the charity. In any event, the RERMS should preferably provide the customer with tax related information upon which they can explore the possibility of taking a tax deduction for the money diverted to charity. Because of the complex taxwise treatment of money diverted to charity via a real estate commission, the RERMS will preferably bring the potential tax deduction issue to the customers attention but also preferably advise the customer to seek advice from a tax professional to aid them in determining the precise tax consequences for that individual in diverting a portion of a real estate commission generated by the customer to a charity.

Another aspect of the invention relates to a potential marketing strategy. In one strategy, the RERMS seeks to associate itself with an employer, and the real estate referral services are offered to employees as an employee benefit. In this manner, the employer is able to offer an extra employee benefit of the type currently offered by large corporations with little or no expense to the corporation. In addition, the employer appears to its employees to be facilitating the transfer of money to charity without the employee having to do anything other than accept a real estate referral, which they might otherwise have to find for themselves. The employees could find it attractive in that they have an opportunity to fund there favorite charity and avoid the effort and uncertainty involved in finding a remote Realtor on their own.

In a preferred marketing strategy, the RERMS markets itself to seek associations with charitable organizations, which have both employees and contributors. Each time an employee of the charitable organization bought or sold real estate, they could take advantage of the referral service and generate funds for their employer charitable organization. In addition, the charitable organization could solicit its contributors with this strategy for how they could increase their contributions to the charity simply by taking advantage of the real estate referral services of the RERMS before engaging in a real estate transaction. Thus, if the RERMS is associated with a charitable organization, each time one of its employees buys or sells real estate, funds would be generated for the charity. In addition, each time a person on their list of contributors changes addresses, there lies an opportunity for the charity to generate even more funds buy one of its contributors also taking advantage of the real estate referral services offered by the RERMS.

The real estate referral market appears to be stable with nominal expansion expected for the future. The overall market is extremely fragmented with every major real estate company and every local real estate company trying to compete. The introduction of the internet has affected the way the industry communicates but does not appear to have affected its size. There are numerous internet referral companies, but none has been able to capture or maintain any significant share of the overall market. Nationally, you have thousands, if not tens of thousands of small players and a few relatively larger companies, none of which control more of 1% of the overall market. The market for these services nonetheless amount to several hundred million dollars in the year 1999. The existing referral industry focuses on those relocating to other cities or other areas of the country. The present invention is applicable to both the traditional relocation marker but also the local market. The area of largest growth in the referral market is in the area of local referrals. One of the attractive aspects of the present invention is that the client, either the buyer or the seller, can specify to whom they wish to be referred to, as long as they contact the RERMS first so that an actual referral can take place. The real estate customer can use their preferred choice Realtor or let the RERMS recommend the Realtor that they can consider most suited to meet the individual customers needs. In addition, they can further interview the referred Realtor, and if they are not happy, the RERMS can recommend a different Realtor.

The present invention faces several risks. Among these are possible new real estate regulations, RERMS taxation issues, and the various states attempt to regulate the internet. The real estate issues have to do mostly with disclosure. When a Realtor “gives” part of his commission to any “interested” party in a real estate transaction, it must be disclosed to all parties to create a “level playing field”. The issue becomes, does this rule apply to referrals as well, and if so, who are the interested parties? Since each state has its own laws and regulations regarding real estate transactions, it is likely that each state will regulate referrals and rebates in a similar manner. Because regulations vary so significantly from one state to another, the RERMS should be established in a state in which real estate commission rebates are legal. Although there are others, one such state is Indiana. Nevertheless, if the RERMS engages in serving out of state customers, it may face governmental regulation from individual state seeking to limit “poaching” of their citizens by “out of state” firms. This issue is looming on the horizon and is tide up in the internet taxation debate. It may be necessary either to open an office in every state, or at least form strategic alliances with real estate broker's in other states.

What is claimed is:

1. A method of motivating submission of a real estate referral, comprising the steps of:
obtaining a real estate broker's license for a real estate referral management system in at least one state;
referring a real estate customer to another licensed real estate broker; and
paying at least a twenty percent portion of a broker referral fee received by the real estate referral management system to a charity chosen by the real estate customer.

2. The method of claim 1 including a step of entering the real estate customer and the real estate referral management system into a written agreement regarding payment of a portion of a broker referral fee to a charity.

3. The method of claim 2 wherein said entering step is performed before said referring step.

4. The method of claim 3 including a step of refraining the real estate referral management system from direct representation of real seat customers in a real estate transaction.

5. The method of claim 4 including a step of offering real estate referral services from the real estate referral management system as an employee benefit to employees of a third party employer.

6. The method of claim 5 including a step of providing the real estate customer with income tax deduction information regarding a portion of a broker referral fee paid to charity.

7. The method of claim 5 including a step of associating the real estate referral management system with at least one third party that does not have a real estate broker's license.

8. The method of claim 7 wherein said at least one third party includes a charitable organization.

9. The method of claim 1 including the steps of:
obtaining membership in the National Association of Realtors for the real estate referral management system; and
ensuring that said another real estate broker is a member of the National Association of Realtors.

10. A method of diverting real estate commission money to a charity, comprising the steps of:
obtaining a real estate broker's license in at least one state for a real estate referral management system that refrains from direct representation of real estate customers in real estate transactions;
entering into an agreement with a real estate customer regarding payment of a portion of a broker referral fee to a charity;
referring the real estate customer to another real estate broker after said entering step; and
paying at least a twenty percent portion of a broker referral fee generated by the real estate customer to a charity chosen by the real estate customer.

11. The method of claim 10 including a step of providing tax deduction information to the real estate customer regarding money paid to a charity from a portion of a broker referral fee.

12. The method of claim 10 including a step of associating the real estate referral management system with at least one third party that does not have a real estate broker's license.

13. The method of claim 12 including a step of offering real estate referral services from the real estate referral management system as an employee benefit to employees of the third party.

14. The method of claim 12 wherein said third party is a charitable organization.

15. The method of claim 10 including the steps of::
obtaining membership in the National Association of Realtors for the real estate referral management system; and
ensuring that said another real estate broker is a member of the National Association of Realtors.

16. A real estate referral management system comprising:
a legal entity having a real estate broker's license;
means for avoiding direct representation of buyers and sellers in real estate transactions;
means for identifying other real estate brokers that do directly represent at least one of buyers and sellers in real estate transactions;
means for referring a real estate customer to one of said other real estate brokers; and
means for legally transferring at least a portion of a broker referral fee to a charity chosen by said real estate customer.

17. The system of claim 16 wherein said legal entity and said one of said other real estate brokers are members of a National Association of Realtors.

18. The system of claim 17 wherein said means for legally transferring includes a written real estate referral fee agreement between said legal entity and said real estate customer.

19. The system of claim 18 wherein said portion of a broker referral fee is at least a twenty percent portion.

20. The system of claim 19 including means for ensuring that said written real estate referral agreement is executed before said real estate customer is referred to said one of said other real estate brokers.
